(19) United States
(12) Patent Application Publication
(10) Pub. No.: US 2023/0398562 A1
(43) Pub. Date: Dec. 14, 2023

(54) DISPENSING DEVICE

(71) Applicant: DAIWA CAN COMPANY, Chiyoda-ku (JP)

(72) Inventor: Hiroya MORITA, Sagamihara-shi (JP)

(73) Assignee: DAIWA CAN COMPANY, Chiyoda-ku (JP)

(21) Appl. No.: 18/250,696

(22) PCT Filed: Oct. 26, 2021
(86) PCT No.: PCT/JP2021/039534

§ 371 Date: Apr. 26, 2023

(30) Foreign Application Priority Data
Oct. 27, 2020 (JP) 2020-179577

(51) Int. Cl. B05B 11/10

(52) U.S. Cl. CPC B05B 11/1047; B05B 11/1001; B05B 11/1067; B05B 11/1098

(57) ABSTRACT

A dispensing device includes an air inlet hole passing through a cylinder in its thickness direction to connect an internal space of the container to an external space; and an action valve fitted onto an outer circumferential surface of the cylinder to close the air inlet hole, and that is isolated from the outer circumferential surface of the cylinder to introduce external air to the container when an internal pressure of the container is lower than an external pressure. An upper end portion of the cylinder is diametrically larger than a lower end portion. The action valve includes a ring-shaped annular section; and a valve section that extends axially from the annular section to close the air inlet hole while maintaining a radial clearance from the air inlet hole, to shield the air inlet hole from the internal space of the container.

### TECHNICAL FIELD

This invention relates to a dispensing device that dispenses contents pushed out of a cylinder by pushing down a nozzle member formed integrally with a piston thereby reducing an inner volume of the cylinder, from a discharging outlet of the nozzle member.

### BACKGROUND ART

Publications of Japanese Patent Nos. 3078012 and 3213249 describe foam dispensing pump containers for dispensing a foam formed by mixing foamable liquid held in the container with air. In each of the containers described therein, an air cylinder is attached to an opening of the container by a lid member, and a liquid cylinder is formed integrally and concentrically with the air cylinder to extend radially inner side of the air cylinder. In addition, a liquid cylinder which is in contact with an inner surface of the liquid cylinder is formed integrally and concentrically with an air piston which is in contact with an inner surface of the air cylinder in a slidable manner. In the air cylinder described in the publication of Japanese Patent No. 3078012, an axially upper end portion is diametrically larger than contact portion. An inlet hole penetrates through the upper end portion of the air cylinder in a thickness direction to introduce external air into the container when an internal pressure of the container is negative, and the inlet hole is closed by a cylindrical action valve that is attached to an outer circumferential surface of the upper end portion. When the internal pressure of the container is substantially in balance with an external pressure, the action valve is brought into contact with the outer circumferential surface of the of the upper end portion. By contrast, when the internal pressure of the container is negative, the action valve is elastically deformed to be detached from the outer circumferential surface of the of the upper end portion so that the inlet hole is opened to introduce the external air into the container.

A diameter of the air cylinder described in the publication of Japanese Patent No. 3213249 is substantially constant over the entire length in its axial direction. An inlet hole penetrates through an upper end portion of the air cylinder in a thickness direction to introduce external air into the container when an internal pressure of the container is negative, and an elastic valve is arranged around the outer circumferential surface of the upper end portion to cover the inlet hole. Specifically, the elastic valve is a cylindrical valve having bulges expanding radially outwardly, and those bulges are in contact with the outer circumferential surface of the air cylinder. That is, the inlet hole is covered by the elastic valve without being in contact with the elastic valve. As the action valve described in the publication of Japanese Patent No. 3078012, the elastic valve comes into contact with the outer circumferential surface of the air cylinder to close the inlet hole when the internal pressure of the container is substantially in balance with the external pressure. By contrast, when the internal pressure of the container is negative, the elastic valve is elastically deformed to be detached from the outer circumferential surface of the air cylinder so that the inlet hole is opened to introduce the external air into the container.

### SUMMARY OF INVENTION

### Technical Problem to be Solved by the Invention

Thus, the above-mentioned action valve and the elastic valve are adapted to introduce the external air into the container only when the internal pressure of the container is negative. That is, the action valve and the elastic valve are brought into contact with the air cylinders in other situations to close the above-mentioned inlet holes thereby preventing intrusion of the liquid held in the container into the air cylinder. In order to ensure such functions, for example, the action valve and the elastic valve may be formed to have inner diameters smaller than the outer diameter of the corresponding air cylinders. Consequently, the action valve and the elastic valve may be brought into close contact with the outer circumferential surfaces of the corresponding air cylinders. In this case, however, the action valve and the elastic valve have to be elastically deformed and moved to installation portions of the air cylinders to be fitted onto the outer circumferential surfaces of the air cylinders. Thus, the action valve and the elastic valve may not be fitted easily onto the air cylinders. In addition, the action valve and the elastic valve are tightly brought into contact with the outer circumferential surfaces of the air cylinders. Therefore, the action valve and the elastic valve will not be detached from the outer circumferential surfaces of the air cylinders to introduce the external air through the inlet holes until the negative pressures in the air cylinders are raised to certain levels. The action valve and the elastic valve may be deformed easily to be fitted smoothly onto the air cylinders by forming those valves using softer material. In this case, however, tightness and sealing ability of the action valve and the elastic valve would be reduced, and for example, those valves would be detached easily from the air cylinders by vibrations during transportation thereby opening the inlet holes undesirably. Consequently, property of the foam would be changed by the liquid intruding into the air chamber through the inlet hole, and the foam would not be dispensed properly due to reduction in an air volume in the air cylinder.

The present invention has been conceived noting the above-explained technical problems, and it is therefore an object of the present invention to provide a dispensing device that can be assembled easily, and that has an action valve actuated stably.

### Means for Solving the Problem

According to the present invention, there is provided a dispensing device, comprising: a cap that is mounted on a neck portion of a container; a cylinder that is fitted onto to an inner section of the cap while being communicated with an internal space of the container; a piston that reciprocates in an axial direction within the cylinder while being in contact with an inner surface of the cylinder; a nozzle member that is reciprocatably attached to the cap to be pushed in the axial direction toward the cylinder thereby pushing the piston; a returning mechanism that pushes the piston back to an initial position; a flow passage passing through the piston in the axial direction; a nozzle hole that is communicated with one of openings of the flow passage; an air chamber that is formed in one of internal spaces of the cylinder divided by the piston to which the other opening of the flow passage opens; a valve mechanism that connects the air chamber to the internal space of the container and the flow passage when the nozzle member is pushed down; an air inlet hole passing through a cylindrical portion of the cylinder in a thickness direction to connect the internal space of the container to an external space; and an action valve that is fitted onto an outer circumferential surface of the cylinder to close the air inlet hole, and that is isolated from the outer circumferential surface of the cylinder to introduce external air to the container when an internal pressure of the container is reduced lower than an external pressure. In order to achieve the above-explained technical problems, according to the exemplary embodiment of the present invention, the cylinder comprises an upper end portion and a lower end portion that is diametrically larger than the upper end portion. In addition, the action valve comprises: a ring-shaped annular section whose inner diameter is larger than at least an outer diameter of the lower end portion; and a valve section that extends from the annular section in the axial direction to close the air inlet hole while maintaining a clearance from the air inlet hole in a radial direction of the container, so as to shield the air inlet hole from the internal space of the container.

According to the present invention, the action valve may further comprise a bulge that is formed on an end portion of the valve section opposite to the annular section to protrude radially inwardly to be in contact airtightly with the outer circumferential surface of the cylinder entirely. In addition, the clearance may be created between the valve section and the outer circumferential surface of the cylinder by bringing the bulge into contact with the outer circumferential surface of the cylinder.

According to the present invention, the annular section may serve as a packing section that is interposed between the cap and the neck portion in the axial direction.

According to the present invention, the upper end portion may include a fitting portion that is formed on the cylinder above the air inlet hole in the axial direction, and the annular section is fitted onto the fitting portion.

According to the present invention, the valve section may have a tapered shape such that inner and outer diameters of the valve section are reduced gradually from the annular section toward a leading edge of the valve section opposite to the annular section in the axial direction.

According to the present invention, the action valve may have hardness within a range from 60 to 90 measured by a durometer of type A defined by JIS-K6253 (ISO7619).

According to the present invention, a thickness of the valve section may be set within a range from 0.3 mm to 2.0 mm.

According to the present invention, an annular bead protruding radially outwardly may be formed entirely on an outer circumferential surface of the upper end portion, and an annular groove into which the annular bead is fitted airtightly may be formed on an inner circumferential surface of the valve section entirely in the vicinity of the annular section.

### Advantageous Effects of Invention

According to the present invention, the upper end portion of the cylinder is diametrically larger than the lower end portion, and the inner diameter of the annular section is larger than at least the outer diameter of the lower end portion. Accordingly, in order to fit the action valve onto the cylinder, the annular section of the action valve is fitted onto the lower end portion of the cylinder, and the action valve is moved toward the upper end portion of the cylinder. Since the inner diameter of the annular section is larger than the outer diameters of the lower end portion of the cylinder, it is possible to slide the action valve easily on the cylinder in the axial direction from the lower end portion to the upper end portion. Thus, the action valve may be fitted easily onto the cylinder. In addition, the valve section of the action valve closes the air inlet hole while maintaining a clearance from the cylinder in the radial direction to shield the air inlet hole from the internal space of the container, and the external air flows into the clearance through the air inlet hole. That is, a contact area of the valve section with the external air, in other words, a pressure receiving area of the valve section is increased by the clearance. Therefore, a load to deform the valve section radially outwardly may be increased when the internal pressure of the container is reduced to the negative pressure. For this reason, the action valve may be deformed certainly to be isolated from the outer circumferential surface of the cylinder by a relatively small negative pressure, thereby opening the air inlet hole to introduce the external air into the container. Whereas, when the internal pressure of the container and the external pressure are substantially in balance with each other, the valve section comes into contact with the outer circumferential surface of the cylinder to close the air inlet hole. Thus, according to the present invention, the action valve may be actuated certainly in response to a change in the internal pressure of the container. Therefore, the action valve will not be isolated easily from the outer circumferential surface of the cylinder by the vibrations during transportation to open the first suction inlet undesirably. For this reason, intrusion of the contents into the cylinder via the air inlet hole can be prevented.

### BRIEF DESCRIPTION OF DRAWINGS

FIG. 1 is a cross-sectional view showing one example of the dispensing device according to the exemplary embodiment of the present invention.

FIG. 2 is a perspective view showing an action valve according to the exemplary embodiment of the present invention.

FIG. 3 is a side view showing the action valve according to the exemplary embodiment of the present invention.

FIG. 4 is a top plane view showing the action valve according to the exemplary embodiment of the present invention.

FIG. 5 is a partial cross-sectional view showing a cross-section of a part of the action valve.

FIG. 6 is a cross-sectional view showing a cross-section of an air cylinder onto which the action valve is fitted.

FIG. 7 is a cross-sectional view showing a cross-section of the air cylinder during a transient state of fitting the action valve.

FIG. 8 is a cross-sectional view showing a cross-section of the air cylinder in a situation where a bulge of the action valve is isolated from an outer circumferential surface of the air cylinder.

### DESCRIPTION OF EMBODIMENT(S)

A dispensing device according to the exemplary embodiment of the present invention is mounted on a mouth of a container to dispense foamable liquid held in the container together with the air by pushing a nozzle member downwardly. In order to pump out the air, the dispensing device is provided with an air cylinder and an air chamber. In order to prevent an internal pressure to be negative, an air inlet hole is formed on the container, and the air inlet hole is closed by an action valve in situations other than introducing the external air into the container. In the dispensing device according to the exemplary embodiment of the present invention, the action valve can be mounted easily on the air cylinder. In addition, the air inlet hole is certainly closed by the action valve to prevent intrusion of the liquid into the air cylinder in situations other than introducing the external air into the container.

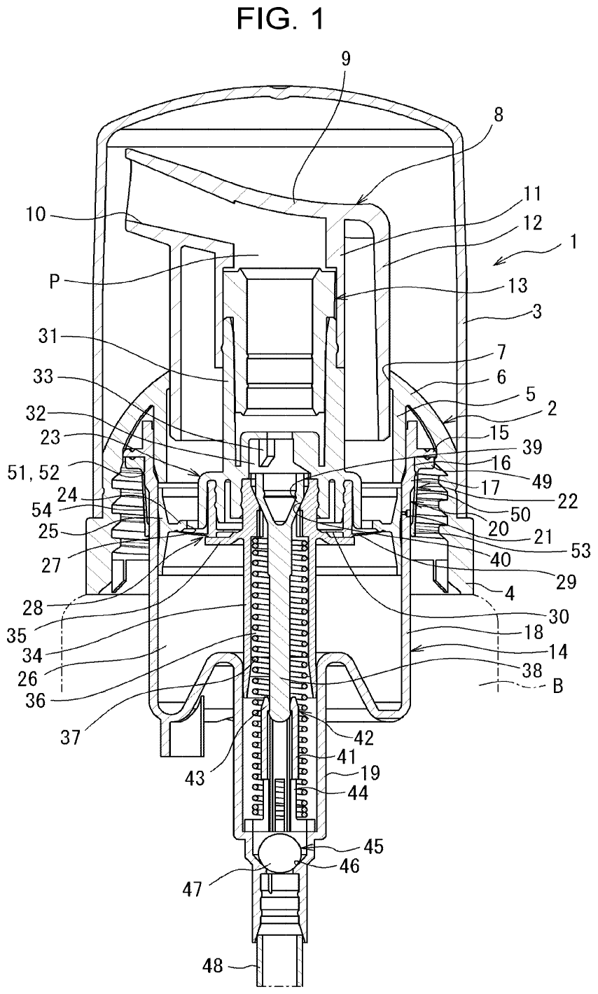

Turning now to FIG. 1, there is shown a cross-section of the dispensing device according to the exemplary embodiment of the present invention. The dispensing device 1 shown in FIG. 1 is a so-called a pump foamer or a pump dispenser adapted to form a foam by mixing foamable (or bubbly) liquid held in a container B and air, and to dispense the foam therefrom. Specifically, the dispensing device 1 shown in FIG. 1 is provided with a base cap (hereinafter simply referred to as cap) 2 that is mounted on a not shown neck portion of the container B in a detachable manner. For example, the container B is a plastic container comprising a cylindrical trunk section and a bottom section formed integrally with the trunk section to close a lower end of the trunk section. The neck portion is a cylindrical opening section formed on an upper end of the trunk section of the container B. A male thread is formed around the neck portion, and a female thread is formed on a cap 2 so that the neck portion is screwed into the cap 2. The above-mentioned foamable (or bubbly) liquid serves as contents of the exemplary embodiment of the present invention.

The dispensing device 1 shown in FIG. 1 comprises an over cap 3 detachably fitted onto the cap 2 to cover an after-mentioned discharging outlet. The over cap 3 is dismounted from the cap 2 to uncover the discharging outlet when dispensing the contents from the discharging outlet, that is, when the dispensing device 1 is in operation. By contrast, in order to prevent an unintentional operation of the dispensing device 1 and to protect the dispensing device 1 from dusts, the over cap 3 is mounted on the cap 2 to cover the discharging outlet when it is not necessary to dispense the contents, that is, when the dispensing device 1 is not in operation.

As illustrated in FIG. 1, the cap 2 comprises an outer cylindrical section 4 whose outer diameter is larger than an outer diameter of the neck portion, and an inner cylindrical section 5 formed concentrically inside the outer cylindrical section 4. Specifically, the inner cylindrical section 5 is a boss section in which an outer diameter is smaller than an inner diameter of the neck portion, and an axial length is shorter than the outer cylindrical section 4. An upper end of the outer cylindrical section 4 and an upper end of the inner cylindrical section 5 are joined to each other through a domed upper section 6 projecting upwardly in a height direction of the dispensing device 1 (i.e., upwardly in FIG. 1). Thus, the outer cylindrical section 4, the inner cylindrical section 5, and the upper section 6 are formed integrally. In addition, the above-mentioned female thread is formed on an inner circumferential surface of the outer cylindrical section 4. An opening 7 whose inner diameter is smaller than an inner diameter of the inner cylindrical section 5 is formed in a center of the upper section 6, and a nozzle member 8 is arranged in the opening 7 while being allowed to reciprocate in the axial direction (i.e., the vertical direction in FIG. 1) to pump out the contents. An outline of a portion of the nozzle member 8 inserted into the opening 7 is substantially in congruent with a shape of the opening 7 so that the nozzle member 8 is allowed to reciprocate in the axial direction along an inner circumferential edge of the opening 7. Specifically, a slight clearance is maintained between the opening 7 and the nozzle member 8 in a radial direction so that the air is allowed to flow through the clearance to be introduced to an upper space of an after-mentioned piston head of the air cylinder.

The nozzle member 8 comprises: a top board 9 as a nozzle head to which a pushing force is applied; a discharging outlet 10 from which the foam is discharged; an inner cylindrical section 11 in which a flow passage P communicated with the discharging outlet 10 is formed; and an outer cylindrical section 12 which is diametrically larger than the inner cylindrical section 11 and situated concentrically around the inner cylindrical section 11. Here, the discharging outlet 10 serves as a nozzle hole of the exemplary embodiment of the present invention. Specifically, the top board 9 is partially shaped into a cylindrical portion extending radially outwardly and upwardly from an axial center of the nozzle member 8, and a leading end of the cylindrical portion serves as the discharging outlet 10. The inner cylindrical section 11 and the outer cylindrical section 12 extend downwardly in FIG. 1 from the top board 9, and the inner cylindrical section 11 is shorter than the outer cylindrical section 12 in the axial direction.

In the example shown in FIG. 1, in order to produce a homogenous foam, a net holder 13 is inserted into the inner cylindrical section 11. Specifically, an inner diameter of the inner cylindrical section 11 is slightly smaller in the section extending from the top board 9, and the net holder 13 is fitted into the section of the inner cylindrical section 11 where the inner diameter is larger such that an upper end of the net holder 13 is brought into contact with a step formed where the inner diameter of the inner cylindrical section 11 is reduced. The net holder 13 is a cylindrical member, and a not shown porous sheet such as a net is attached to each axial end of the net holder 13. As explained later, the foam produced by mixing the liquid and the air is let through the net holder 13 to be refined and homogenized.

A cylinder 14 is arranged inside of the cap 2. As illustrated in FIG. 1, the cylinder 14 is fitted onto the inner cylindrical section 5 of the cap 2 to be integrated therewith. A flange 15 expands from an upper end portion of the cylinder 14 that is fitted onto the inner cylindrical section 5, and an outer diameter of the flange 15 is equal to or slightly larger than an outer diameter of a leading end (i.e., an opening end) of the neck portion. In order to ensure airtightness and liquid-tightness, an after-mentioned annular section of the action valve as a sealing section or a packing section is interposed between the leading end (i.e., the opening end) of the neck portion and a lower surface (in FIG. 1) of the flange 15. As an option, a contact ring may be interposed between the flange 15 and the annular member of the action valve to enhance the airtightness and the liquid-tightness.

The annular member of the action valve is fitted onto a fitting portion 16 formed below the flange 15 of the cylinder 14, and an inner diameter and an outer diameter of the fitting portion 16 are larger than an inner diameter and an outer diameter of the air cylinder formed axially below the fitting portion 16 of the cylinder 14. That is, a stepped portion 17 in which the inner diameter and the outer diameter of the cylinder 14 are changed is formed below the fitting portion 16 of the cylinder 14. Specifically, the outer diameter of the stepped portion 17 is slightly smaller than the outer diameter of the fitting portion 16, but slightly larger the outer diameter of the air cylinder. Whereas, the inner diameter of the stepped portion 17 is reduced gradually from the fitting portion 16 toward the air cylinder. Accordingly, the fitting portion 16 and the stepped portion 17 correspond to an upper end portion of the exemplary embodiment of the present invention.

Here will be explained a structure of the cylinder 14 in more detail. The cylinder 14 comprises: an air cylinder 18 of an air pump that pumps air to the nozzle member 8; and a liquid cylinder 19 of a liquid pump that pumps the liquid to the nozzle member 8. Specifically, the air cylinder 18 is formed integrally with the fitting portion 16 to extend axially downwardly therefrom, and in order to introduce air to the container B, a first suction inlet 21 as an air inlet hole of the exemplary embodiment of the present invention is formed on an upper end portion 20 of the air cylinder 18 by piercing the air cylinder 18 in its thickness direction. In the embodiment shown herein, the upper end portion 20 of the air cylinder 18 is defined as a portion of the air cylinder 18 above an axially central portion of the air cylinder 18 or the cylinder 14. The above-mentioned stepped portion 17 is formed in the upper end portion 20, and the fitting portion 16 is formed above the stepped portion 17 of the upper end portion 20.

In the air cylinder 18, an inner diameter of a cylindrical portion of the air cylinder 18 below the stepped portion 17 is substantially constant entirely in the axial direction. Whereas, an outer diameter of the cylindrical portion below the stepped portion 17 is smaller than that of the stepped portion 17, and substantially constant entirely in the axial direction. In addition, in the dispensing device 1 according to the exemplary embodiment of the present invention, the action valve 22 is fitted onto the upper end portion 20 of the air cylinder 18. Therefore, it is possible to prevent intrusion of the liquid into the after-mentioned air chamber through the first suction inlet 21 during the transportation of the container B on which the dispensing device 1 is mounted and which is filled with the liquid. A structure of the action valve 22 will be explained later.

Whereas, the liquid cylinder 19 is diametrically smaller than the air cylinder 18, and is formed concentrically with the air cylinder 18. Specifically, as illustrated in FIG. 1, the liquid cylinder 19 partially projects into the air cylinder 18 from radially inner side of the air cylinder 18. That is, the liquid cylinder 19 is formed concentrically with the air cylinder 18, and the liquid cylinder 19 overlaps with the air cylinder 18 at least partially in the radial direction. In this example, the liquid cylinder 19 is formed integrally with the air cylinder 18. As illustrated in FIG. 1, a boundary between the air cylinder 18 and the liquid cylinder 19 is curved to protrude upwardly in FIG. 1 so that a flange of an after-mentioned liquid piston comes into contact with the boundary when the liquid piston is pushed down. That is, the protrusion between the air cylinder 18 and the liquid cylinder 19 is a stroke end as a lower limit position of the piston pushed into the container B.

An air piston 23 is fitted into the air cylinder 18 while being in contact airtightly with an inner circumferential surface of the air cylinder 18, and being allowed to reciprocate in the axial direction (i.e., the vertical direction in FIG. 1). That is, the air cylinder 18 and the air piston 23 serve as the air pump. The air piston 23 comprises: a piston head 24 that divides an internal space of the air cylinder 18 into an upper space and a lower space; and a contact portion 25 that is formed integrally with the piston head 24 to be in contact with the inner circumferential surface of the air cylinder 18. In the example shown in FIG. 1, the internal space of the air cylinder 18 below the piston head 24 serves as an air chamber 26. Specifically, the contact portion 25 is a cylindrical portion, and an upper cylindrical section and a lower cylindrical section of the contact portion 25 are in contact airtightly with the inner circumferential surface of the air cylinder 18 in a slidable manner. Thus, the above-mentioned first suction inlet 21 is opened and closed by reciprocating the contact portion 25 in the axial direction. As described, the fitting portion 16 of the air cylinder 18 is fitted onto the inner cylindrical section 5. Therefore, the contact portion 25 is brought into contact airtightly with a portion of the inner circumferential surface of the air cylinder 18 other than the fitting portion 16, that is, to a portion of the inner circumferential surface of the air cylinder 18 below the stepped portion 17.

In order to introduce air to the air chamber 26, a second suction inlet 27 as a through hole is formed on a predetermined portion of the piston head 24. Further, in order to selectively connect the air chamber 26 to the external space of the container B and an after-mentioned mixing chamber depending on an internal pressure of the air chamber 26, a valve element 28 is attached to the piston head 24 at a radially inner side of the second suction inlet 27.

The valve element 28 comprises: a cylindrical stem that is fitted into a recess formed on the piston head 24; an annular outward valve portion 29 expanding radially outwardly from an end portion of the cylindrical stem protruding from the recess; and an annular inward valve portion 30 expanding radially inwardly from the end portion of the cylindrical stem protruding from the recess. Specifically, the outward valve portion 29 covers the second suction inlet 27 in the air chamber 26 from an inner side. That is, when an internal pressure of the air chamber 26 is higher than an external pressure outside of the container B, the second suction inlet 27 is closed by the outward valve portion 29. By contrast, the second suction inlet 27 is opened when the internal pressure of the air chamber 26 is lower than the external pressure outside of the container B. Thus, the outward valve portion 29 serves as an air-suction valve to selectively allow and inhibit the external air to enter the air chamber 26. Therefore, in the following explanations, the outward valve portion 29 will be referred to as the air-suction valve 29. On the other hand, the inward valve portion 30 is in contact with the flange of the after-mentioned liquid piston. That is, when the internal pressure of the air chamber 26 is higher than the external pressure outside of the container B, the air chamber 26 is connected to the mixing chamber by the inward valve portion 30. By contrast, the air chamber 26 is disconnected from the mixing chamber when the internal pressure of the air chamber 26 is lower than the external pressure outside of the container B. Thus, the inward valve portion 30 serves as an air-discharging valve to selectively supply the air in the air chamber 26 to the mixing chamber or push out the air from the mixing chamber. Therefore, in the following explanations, the inward valve portion 30 will be referred to as the air-discharging valve 30.

A cylindrical section 31 extends (upwardly in FIG. 1) from a radially central portion of the piston head 24 in an opposite direction to the container B. The inner cylindrical section 11 of the nozzle member 8 is fitted onto one end (i.e., an upper end in FIG. 1) of the cylindrical section 31, and a lower end of the net holder 13 is fitted into said one end of the cylindrical section 31. In the example shown in FIG. 1, a ridge is formed on an outer circumferential surface of said one end of the cylindrical section 31, and a groove formed on an inner circumferential surface of the inner cylindrical section 11 is engaged with the ridge of the cylindrical section 31. Thus, the cylindrical section 31 is firmly joined to the inner cylindrical section 11 by engaging the ridge with the groove. Instead, the cylindrical section 31 may also be joined to the inner cylindrical section 11 by a screw, a tightening method, a transition fit or the like. In addition, an upper section of the net holder 13 is larger than a lower section thereof so that the net holder 13 comes into contact with a leading end of the cylindrical section 31 so as to prevent disengagement of the net holder 13 downwardly in the axial direction.

A mixing chamber 32 is formed in the other end (i.e., a lower end in FIG. 1) of the cylindrical section 31. In the mixing chamber 32, the air pushed out of the air chamber 26 is mixed with the liquid pushed out of the after-mentioned liquid chamber to form a foam. In the example shown in FIG. 1, a hollow section protrudes from the mixing chamber 32 toward the lower end of the cylindrical section 31, and a through hole is formed on a leading end of the hollow section to serve as an orifice. Therefore, the foam formed in the mixing chamber 32 can be spurted out of the orifice. In addition, a projection 33 as a plate section is formed in the mixing chamber 32 to protrude radially inwardly. Therefore, when the air piston 23 is pushed down to a certain extent toward the container B, the projection 33 comes into contact with an upper end of a valve element formed on one end of an after-mentioned shaft member thereby pushing the shaft member toward the container B. To this end, when the air piston 23 is positioned at an upper limit position as illustrated in FIG. 1, a predetermined clearance is maintained between the projection 33 and the upper end of the valve element of the shaft member.

A liquid piston 34 of the liquid pump is engaged with the other end of the cylindrical section 31 below the mixing chamber 32. As illustrated in FIG. 1, the liquid piston 34 is a cylindrical member extending in the axial direction, and one end of the liquid piston 34 (i.e., an upper end in FIG. 1) is engaged with the other end of the cylindrical section 31. Specifically, the other end of the cylindrical section 31 is depressed in the axial direction to expand an inner diameter, and said one end of the liquid piston 34 is fitted into the depression of the cylindrical section 31. Although not especially shown, an air passage is formed between the depression and said one end of the liquid piston 34. One end of the above-mentioned air passage is connected to the mixing chamber 32, and the other end of the above-mentioned air passage is connected to a space between the liquid piston 34 and the air piston 23. As described, when the top board 9 of the nozzle member 8 is pushed down toward the container B, the air piston 23 is pushed down toward the container B so that a substantial inner volume of the air chamber 26 is reduced. Consequently, the air chamber 26 is pressurized so that the air is pushed out of the air chamber 26. Specifically, the air-discharging valve 30 is opened so that the air is pushed out of the air chamber 26 to flow into the space between the liquid piston 34 and the air piston 23. Consequently, the air flows into the mixing chamber 32 via the air passage.

As described, in order to define the lower limit positions of the air piston 23 and the liquid piston 34, a flange 35 expanding radially outwardly is formed on an outer circumferential surface of one end of the liquid piston 34. For example, when the nozzle member 8 is positioned at an upper limit position as illustrated in FIG. 1, the air-discharging valve 30 is brought into contact with an upper surface of the flange 35. The other end of the liquid piston 34 is fitted into the liquid cylinder 19 liquid-tightly while being allowed to reciprocate in the axial direction (i.e., in the vertical direction in FIG. 1). Thus, the liquid cylinder 19 and the liquid piston 34 serve as the above-mentioned liquid pump, and a cylindrical space in the liquid cylinder 19 and the liquid piston 34 serves as a liquid chamber 36. When the top board 9 of the nozzle member 8 is pushed down toward the container B, the liquid piston 34 is pushed down toward the container B so that a substantial inner volume of the liquid chamber 36 is reduced. Consequently, the liquid chamber 36 is pressurized so that the liquid is pushed out of the liquid chamber 36, and then flows into the mixing chamber 32.

The air chamber 26 and the liquid chamber 36 are configured such that a volume ratio between the air pushed out of the air chamber 26 and the foamable (or bubbly) liquid (i.e., the contents) falls within a range from 16 to 30. Therefore, an expansion ratio of the foam to be dispensed falls within the range from 16 to 30, and a foam density falls within a range from 0.03 g/cm³ to 0.06 g/cm³. Specifically, the expansion ratio of the foam to be dispensed may be expressed as:

16≤(DA²−DL²)/DL²≤30;

where DA is an inner diameter of the air cylinder 18, and DL is an inner diameter of the liquid cylinder 19. In the above expression, specifically, DA is an average inner diameter of the air cylinder 18 within a sliding range of the air piston 23, and DL is an average inner diameter of the liquid cylinder 19 within a sliding range of the liquid piston 34. It is to be noted that the lower limit value “16” and the upper limit value “30” are rounded to be integers taking account of measurement errors. That is, the lower limit value includes 16 having a decimal value, and the upper limit value includes 30 having a decimal value.

When the pushing force pushing the nozzle member 8 and the pistons 23 and 34 toward the container B is cancelled, the nozzle member 8 and the pistons 23 and 34 are returned to the initial positions by a returning mechanism arranged in the liquid chamber 36. The liquid chamber 36 is connected to an internal space of the container B and to the mixing chamber 32 and the flow passage P by a valve mechanism also arranged in the liquid chamber 36, in response to a pushing operation of the nozzle member 8. According to the exemplary embodiment, a coil spring (hereinafter simply referred to as spring) 37 serves as the returning mechanism to return the nozzle member 8 and the pistons 23 and 34 to the initial positions. Specifically, the spring 37 is arranged between a receiving section formed on the other end of the liquid piston 34 and a receiving section formed on an inner circumference of a bottom of the liquid cylinder 19 while being compressed. That is, the liquid piston 34 is always pushed toward an opposite side to the container B (i.e., upwardly in FIG. 1) by an elastic force of the spring 37.

The valve mechanism comprises a shaft member 38 arranged along a center axis of the liquid cylinder 19. One end (i.e., an upper end in FIG. 1) of the shaft member 38 protrudes from said one end of the liquid piston 34, and a valve element 39 is formed on said one end of the shaft member 38. Specifically, the valve element 39 is a tapered section in which an outer diameter of the valve element 39 increases gradually toward said one end of the shaft member 38. On the other hand, an annular protrusion protruding radially inwardly toward a center of the flow passage P is formed on said one end (i.e., an upper end in FIG. 1) of the liquid piston 34. Specifically, the annular protrusion is situated closer to the container B than the valve element 39, and a minimum inner diameter of the annular protrusion is smaller than an outer diameter of the valve element 39 so that the annular protrusion is engaged with a tapered surface of the valve element 39. In addition, an upper surface (facing to the tapered surface of the valve element 39) of the annular protrusion is also tapered such that the inner diameter increases gradually toward the upper end. Therefore, the annular protrusion is allowed to contact with the valve element 39 from below to close the flow passage P and the liquid chamber 36 in a liquid-tight manner. Thus, the annular protrusion serves as a valve seat 40.

In the example shown in FIG. 1, the other end (i.e., a lower end in FIG. 1) of the shaft member 38 opposite to the valve element 39 is shaped into an arrowhead shape pointing downwardly having a triangular cross-section. The other end of the shaft member 38 is inserted into a cylindrical retaining member 41 arranged in a bottom of the liquid cylinder 19 in such a manner as to slide on an inner circumferential surface of the retaining member 41. Specifically, an outer diameter of the lower end of the shaft member 38 is slightly larger than an inner diameter of the retaining member 41, and the lower end of the shaft member 38 is pushed into the retaining member 41 while being shrunk elastically. That is, an outer circumferential surface of the lower end of the shaft member 38 is elastically pushed onto the inner circumferential surface of the retaining member 41. Therefore, when the shaft member 38 is not pushed downwardly by a load applied thereto, an axial movement of the shaft member 38 is prevented by an elastic force of the lower end of the shaft member 38 and a frictional force acting between the outer circumferential surface of the lower end of the shaft member 38 and the inner circumferential surface of the retaining member 41. Thus, the lower end of the shaft member 38 serves as a plug 42 inserted into the retaining member 41.

An inner circumferential portion of one end (i.e., an upper end in FIG. 1) of the retaining member 41 is also shaped into an arrowhead shape having a triangular cross-section to serve as a hook 43 engaged with an expanded base portion of the plug 42 of the shaft member 38. Therefore, the shaft member 38 is retained within the retaining member 41 by the hook 43, and the nozzle member 8 and the pistons 23 and 34 are prevented from being pulled upwardly further than the upper limit positions. Those upper limit positions are initial positions or stroke ends of the nozzle member 8 and the pistons 23 and 34. A plurality of slits 44 as flow passages of the liquid contents are formed on a lower surface of the retaining member 41 in such a manner as to extend in the axial direction at regular intervals in a circumferential direction. As explained below, since an internal space of the retaining member 41 is connected to the internal space of the container B, the liquid contents is allowed to flow into the liquid chamber 36 through the slits 44 from the internal space of the retaining member 41.

A check valve is arranged in the bottom of the liquid cylinder 19. The check valve is opened to take up the liquid contents from the internal space of the container B to the liquid chamber 36, and closed to push out the liquid contents from the liquid chamber 36. In the exemplary embodiment, a ball valve 45 is adopted as the check valve, and a valve seat 46 is formed in the bottom of the liquid cylinder 19. Specifically, the valve seat 46 has a tapered shape in which an inner diameter thereof increases gradually upwardly, and a ball 47 is in contact with a tapered surface of the valve seat 46 from above. In order to introduce the liquid contents held in the container B to the liquid chamber 36, the bottom of the liquid cylinder 19 is joined to a tube 48 extending to the vicinity of a not shown bottom of the container B.

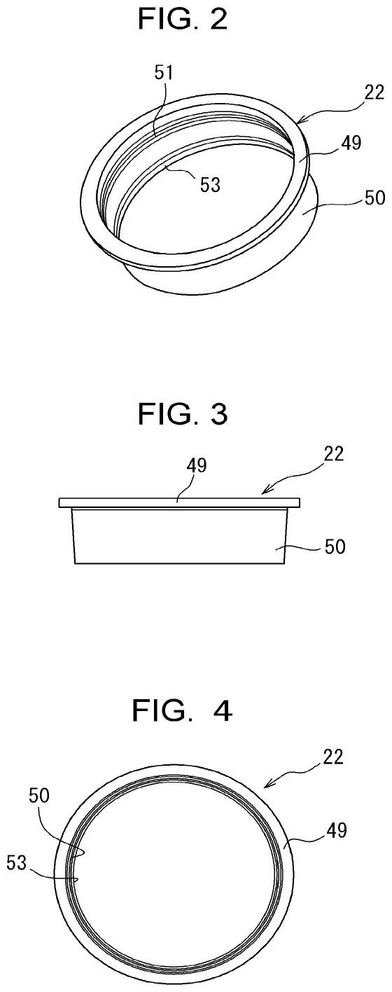

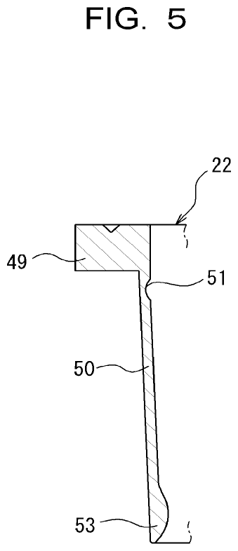

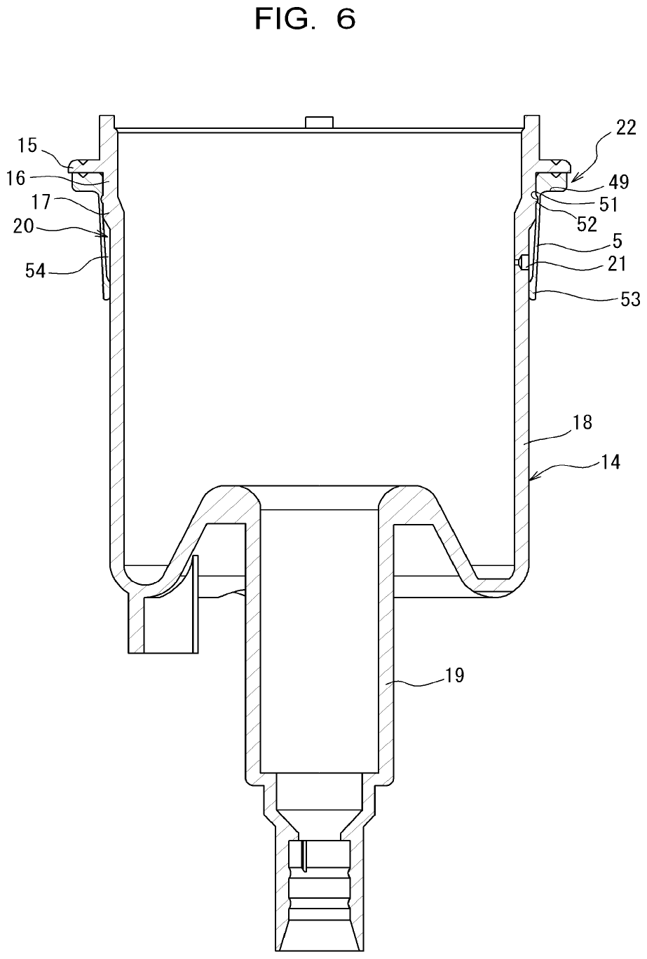

Next, here will be explained a structure of the action valve 22. FIG. 2 is a perspective view of the action valve 22 according to the exemplary embodiment of the present invention, FIG. 3 is a side view of the action valve 22 according to the exemplary embodiment of the present invention, FIG. 4 is a top plane view of the action valve 22 according to the exemplary embodiment of the present invention, FIG. 5 is a partial cross-sectional view showing a cross-section of a part of the action valve 22 according to the exemplary embodiment of the present invention, and FIG. 6 is a cross-sectional view showing a cross-section of the air cylinder 18 onto which the action valve 22 is fitted. The action valve 22 is fitted liquid-tightly onto the outer circumferential surface of the air cylinder 18, and is deformed elastically by a change in the internal pressure of the container B resulting from reciprocation of the nozzle member 8 thereby opening and closing the first suction inlet 21. In the example shown herein, the action valve 22 comprises a ring-shaped annular section 49, and a cylindrical valve section 50 formed integrally with the annular section 49 to extend downwardly from the annular section 49. Provided that the annular section 49 is unloaded before fitted onto the air cylinder 18, an inner diameter of the annular section 49 is larger than at least an outer diameter of the lower end of the air cylinder 18, and slightly larger than an outer diameter of the fitting portion 16 of the air cylinder 18. Therefore, the action valve 22 may be fitted easily onto the air cylinder 18.

In the situation where the annular section 49 is unloaded before fitted onto the air cylinder 18, an outer diameter of the annular section 49 is substantially identical to or slightly larger than an outer diameter of a leading end of the neck portion of the container B. However, as illustrated in FIGS. 1 and 6, the outer diameter of the annular section 49 is substantially identical to or slightly smaller than an outer diameter of the flange 15 of the cylinder 14. Therefore, the annular section 49 is allowed to be interposed between the leading end (i.e., an opening end) of the neck portion and the flange 15 of the air cylinder 18 to serve as a packing section or a sealing section for enhancing the liquid-tightness of the container B.

As illustrated in FIGS. 2, 3, and 5, the valve section 50 has a tapered shape such that inner and outer diameters thereof are reduced gradually from the annular section 49 toward a leading edge thereof opposite to the annular section 49 in the axial direction. A length of the valve section 50 in the axial direction is shorter than a length of the upper end portion of the air cylinder 18.

As illustrated in FIGS. 5 and 6, an upper portion of an inner circumferential surface of the valve section 50 is slightly depressed radially outwardly to form an annular groove 51, and an annular bead 52 is formed on an outer circumferential surface of the fitting portion 16 of the air cylinder 18 to be fitted into the annular groove 51. In the situation where the annular bead 52 is unloaded, an outer diameter of the annular bead 52 at a ridge thereof in a radial direction is larger than an inner diameter of the annular groove 51 at a bottom thereof in the radial direction. Therefore, the valve section 50 is deformed elastically by fitting the annular bead 52 into the annular groove 51 so that the airtightness between the annular bead 52 and the annular groove 51 is ensured. In addition, a position of the action valve 22 on the air cylinder 18 is fixed and the action valve 22 is no longer allowed to move in the axial direction.

A bulge 53 protruding radially inwardly is formed on a lower end of the valve section 50 in the axial direction to be brought into contact with the outer circumferential surface of the upper end portion 20 of the air cylinder 18. In the example shown herein, an inner surface of the bulge 53 is an arcuate surface bulging radially inwardly, and a curvature of the inner surface of the bulge 53 is substantially constant. In other words, as illustrated in FIGS. 5 and 6, the bulge 53 has a bulging arcuate cross-section. In the situation where the bulge 53 is unloaded, an inner diameter of the inner surface of the bulge 53 is slightly smaller than an outer diameter of the upper end of the air cylinder 18. Therefore, the bulge 53 can be brought into contact airtightly with the entire circumference of the upper end of the air cylinder 18. In the situation where the valve section 50 is unloaded, an inner diameter of a portion of the valve section 50 other than the bulge 53 is larger than at least the outer diameter of the air cylinder 18. Therefore, as the above-mentioned annular groove 51, the bulge 53 is deformed elastically by fitting the action valve 22 onto a predetermined portion of the air cylinder 18 so that the bulge 53 is brought into contact airtightly with the entire circumference of the upper end of the air cylinder 18. Thus, as illustrated in FIGS. 1 and 6, the annular groove 51 formed on the upper end of the action valve 22 and the bulge formed on the lower end of the action valve 22 are brought into contact with the outer circumferential surface of the air cylinder 18. Consequently, a slight clearance 54 is created between the outer circumferential surface of the air cylinder 18 and the valve section 50, and the first suction inlet 21 is shielded from the internal space of the container B. Here, an overlapping amount as a difference between the inner diameter of the bulge 53 and the outer diameter of the upper end of the air cylinder 18 is set taking account of the sealing ability and tightness between the action valve 22 and the outer circumferential surface of the air cylinder 18, and an easiness to fit the action valve 22 onto the air cylinder 18.

Thus, the clearance 54 is maintained between the outer circumferential surface of the air cylinder 18 and the valve section 50 of the action valve 22. The clearance 54 is communicated with the outer space of the container B via the first suction inlet 21 when the air piston 23 is pushed toward the container B thereby moving the contact portion 25 below the first suction inlet 21. Consequently, an external pressure outside the container B, that is, an atmospheric pressure is applied to the clearance 54. A space opposite to the clearance 54 across the valve section 50 in the radial direction is the internal space of the container B. That is, not only the internal pressure of the container B but also the external pressure is applied to the valve section 50 so that the clearance 54 serves as an air chamber that deforms the valve section 50 elastically in the radial direction in accordance with a difference between the internal pressure of the container B and the atmospheric pressure. In the following explanations, the clearance 54 will be referred to as the air chamber 54.

Here will be explained dimensions of the air cylinder 18 and the action valve 22 before fitting the action valve 22 onto the air cylinder 18. In the example shown herein, the outer diameter of the fitting portion 16 is 24.6 mm, the outer diameter of the stepped portion 17 is 24.3 mm, and the outer diameter of the outer circumferential surface of the air cylinder 18 to be in contact with the bulge 53 of the action valve 22 is 24.1 mm. Whereas, the inner diameter of the bulge 53 of the action valve 22 is 23.8 mm. Accordingly, an overlapping amount as a difference between the inner diameter of the bulge 53 and the outer diameter of the upper end of the air cylinder 18 is 0.15 mm. The inner diameter of the valve section 50 is set at least to 24.3 mm. Therefore, in the example shown herein, a width or height of the air chamber 54 in the radial direction as a clearance between the outer circumferential surface of the air cylinder 18 and the inner surface of the valve section 50 opposed thereto is approximately 0.2 mm. The inner diameter of the annular section 49 is 24.7 mm, and a thickness of the valve section 50 is 0.3 mm.

For example, the action valve 22 is made of synthetic resin, and as described, the action valve 22 is elastically deformed in accordance with the above-mentioned pressure difference. Consequently, the action valve 22 is isolated from the outer circumferential surface of the air cylinder 18 to open the first suction inlet 21 so that the air is allowed to flow into the container B. Whereas, in the situation where the above-mentioned pressure difference is small or none, the action valve 22 is brought into contact airtightly with the outer circumferential surface of the air cylinder 18 to close the first suction inlet 21. Thus, the action valve 22 is deformed elastically by the pressure difference to open and close the first suction inlet 21. To this end, the material of the action valve 22 is not limited to specific material.

Here will be explained a deformability of the action valve 22, that is, hardness of the synthetic resin as the material of the action valve 22 and a thickness of the action valve 22. According to the exemplary embodiment of the present invention, the action valve 22 is formed of elastic material having hardness within a range from 60 to 90 measured by a durometer of type A defined by JIS-K6253 (ISO7619). If the durometer hardness of the elastic material is less than 60, the valve section 50 would be too soft and deformed undesirably by vibrations during transportation. Consequently, the bulge 53 would be detached from the outer circumferential surface of the air cylinder 18 thereby reducing a sealing tightness of the first suction inlet 21. Therefore, in order to avoid such disadvantage, the elastic material having a durometer hardness harder than 60 is used to form the action valve 22.

By contrast, if the durometer hardness of the elastic material is greater than 90, the valve section 50 would be too hard. In this case, the valve section 50 will not be deformed easily by the pressure difference between the internal pressure of the container B and the external pressure even if the internal pressure of the container B is reduced to the negative pressure. Therefore, the bulge 53 would not be isolated easily from the outer circumferential surface of the air cylinder 18. That is, the external air may not be introduced to the container B even if the internal pressure of the container B is reduced to the negative pressure. In order to avoid such disadvantage, the elastic material having a durometer hardness less than 90 is used to form the action valve 22. In addition, if the durometer hardness of the elastic material is greater than 90, the annular section 49 would also be too hard to be deformed. In this case, clearances would be created between the leading end of the neck portion and the annular section 49 and between the flange 15 of the air cylinder 18 and the annular section 49 even after fitting the annular section 49 between the leading end of the neck portion and the flange 15 of the air cylinder 18. Therefore, the airtightness and the liquid-tightness of the container B may not be ensured. In order to avoid such disadvantage, the elastic material having a durometer hardness less than 90 is used to form the action valve 22. In order to enhance the tightness of the action valve 22 to seal the first suction inlet 21 and to certainly actuate the action valve 22 by the above-mentioned pressure difference, it is preferable to use the elastic material having a durometer hardness within a range from 70 to 85 to form the action valve 22.

According to the exemplary embodiment of the present invention, a thickness of the valve section 50 is set within a range from 0.3 mm to 2.0 mm. If the thickness of the valve section 50 is thinner than 0.3 mm, a second moment of area of the valve section 50 would be too small. In this case, as the case that the durometer hardness of the elastic material is insufficient, the valve section 50 would be deformed undesirably by the vibrations during transportation. Consequently, the bulge 53 would be detached from the outer circumferential surface of the air cylinder 18 thereby reducing a sealing tightness of the first suction inlet 21. Therefore, in order to avoid such disadvantage, the thickness of the valve section 50 is set thicker than 0.3 mm.

By contrast, if the thickness of the valve section 50 is thicker than 2.0 mm, a second moment of area of the valve section 50 would be too large. In this case, the valve section 50 will not be deformed easily by the pressure difference between the internal pressure of the container B and the external pressure even if the internal pressure of the container B is the negative pressure. Therefore, the bulge 53 would not be isolated easily from the outer circumferential surface of the air cylinder 18. That is, as the case that the durometer hardness of the elastic material is too hard, the external air may not be introduced to the container B even if the internal pressure of the container B is reduced to the negative pressure. Therefore, in order to avoid such disadvantage, the thickness of the valve section 50 is set thinner than 2.0 mm.

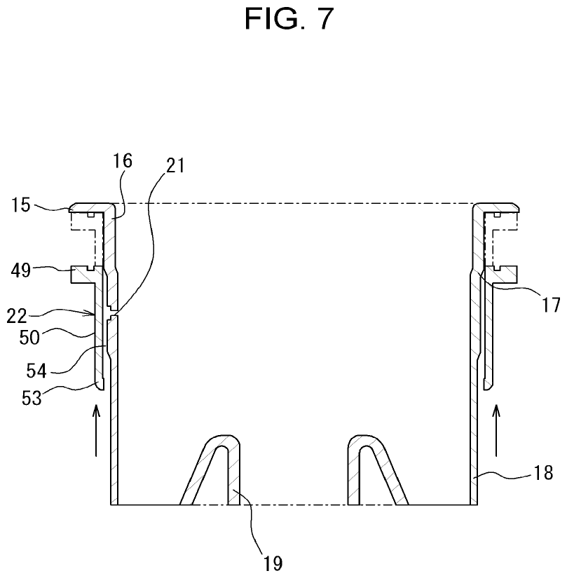

Next, here will be explained procedures of fitting the action valve 22 onto the air cylinder 18. Turning to FIG. 7, there is shown a cross-section of the air cylinder 18 during a transient state of fitting the action valve 22 onto the air cylinder 18. First of all, the annular section 49 of the action valve 22 is fitted onto the lower end of the air cylinder 18. In other words, the lower end of the air cylinder 18 is inserted into the annular section 49. In this situation, the action valve 22 is moved toward the fitting portion 16. As described, the inner diameter of the annular section 49 is larger than the outer diameters of the fitting portion 16 and the lower end of the air cylinder 18 so that it is possible to slide the action valve 22 easily on the outer circumferential surface of the air cylinder 18 in the axial direction. Since the inner diameter of the bulge 53 of the action valve 22 is smaller than the outer diameter of the air cylinder 18, an engagement force is established at a contact site therebetween. Although such engagement force hinders movement of the action valve 22, according to the exemplary embodiment of the present invention, the action valve 22 is not brought into contact with the outer circumferential surface of the air cylinder 18 except for the bulge 53. Therefore, the action valve 22 is allowed to slide to the fitting portion 16 relatively smoothly, compared to a case in which the action valve 22 is brought into contact entirely with the outer circumferential surface of the air cylinder 18.

In addition, since the inner diameter of the annular section 49 is larger than the outer diameter of the stepped portion 17, the annular section 49 is allowed to slide over the stepped portion 17 to the fitting portion 16. As described, the annular bead 52 is formed on the fitting portion 16. Therefore, for example, the annular bead 52 may be fitted into the annular groove 51 formed on the valve section 50 of the action valve 22 by elastically expanding the annular section 49 radially outwardly by fingers. Consequently, since the outer diameter of the annular bead 52 is larger than the inner diameter of the annular groove 51, the annular bead 52 is brought into contact liquid-tightly and airtightly with the annular groove 51. In addition, a position of the action valve 22 on the air cylinder 18 is fixed. Likewise, the bulge 53 is also brought into contact liquid-tightly and airtightly with the outer circumferential surface of the air cylinder. Thus, the annular groove 51 formed on the upper end of the action valve 22 and the bulge 53 formed on the lower end of the action valve 22 are brought into contact with the entire outer circumferential surface of the air cylinder 18 liquid-tightly and airtightly. Consequently, the air chamber 54 is created between the action valve 22 and the air cylinder 18, and the first suction inlet 21 is shielded from the internal space of the container B.

Here will be explained an action of the dispensing device 1 according to the exemplary embodiment of the present invention. As illustrated in FIG. 1, in the situation where the pushing force is not applied to the nozzle member 8, the nozzle member 8 is positioned at the upper limit position. Specifically, in the situation illustrated in FIG. 1, the pistons 23 and 34 are pushed upwardly (in FIG. 1) in the cylinders 18 and 19 by the elastic force of the spring 37. Consequently, the valve seat 40 formed on said one end of the liquid piston 34 is pushed onto the valve element 39 of the shaft member 38 thereby disconnecting the liquid chamber 36 from the mixing chamber 32 and the flow passage P. In this situation, the plug 42 of the shaft member 38 is retained within the retaining member 41 by the hook 43, and the ball 47 of the ball valve 45 is brought into contact with the valve seat 46 under its own weight and by a weight of the contents in the liquid chamber 36 so that the liquid chamber 36 is also disconnected from the internal space of the container B. In addition, the first suction inlet 21 formed on the air cylinder 18 is closed by the contact portion 25 of the air piston 23. On the other hand, the second suction inlet 27 is closed by the air-suction valve 29, and the flange 35 of the liquid piston 34 is brought into contact with the air-discharging valve 30. That is, both of the air-suction valve 29 and the air-discharging valve 30 are closed. In the action valve 22, the valve section 50 covers the first suction inlet 21 from outside of the air cylinder 18 while maintaining a slight clearance therebetween, and the inner circumferential surface of the bulge 53 is in close contact with the outer circumferential surface of the upper end of the air cylinder 18. That is, the first suction inlet 21 is shielded from the outer space of the air cylinder 18 by the action valve 22.

As described, according to the exemplary embodiment of the present invention, the durometer hardness of the elastic material of the action valve 22 and the thickness of the valve section 50 are optimized to ensure the sealing tightness of the first suction inlet 21, even if the action valve 22 is vibrated during transportation. Therefore, in the situation shown in FIG. 1, the action valve 22 will not be deformed easily by the vibrations during transportation so that the first suction inlet 21 is certainly shielded from the internal space of the container B by the action valve 22 during transportation. That is, the action valve 22 will not be isolated easily from the outer circumferential surface of the air cylinder 18 by the vibrations during transportation to open the first suction inlet 21 undesirably. For this reason, intrusion of the contents into the air cylinder 18 and the air chamber 26 via the first suction inlet 21 can be prevented.

When the nozzle member 8 is slightly pushed down from the upper limit position, the pistons 23 and 34 are also pushed down toward the container B by the pushing force applied to the nozzle member 8. In this situation, the plug 42 of the shaft member 38 is elastically and frictionally pushed onto the inner circumferential surface of the retaining member 41. That is, in this situation, a force other than the frictional force and the elastic force is not applied to the shaft member 38, therefore, the shaft member 38 is fixed by the retaining member 41 with respect to the cylinders 18 and 19. In this situation, however, the shaft member 38 is allowed to move relatively to the liquid piston 34. Specifically, the shaft member 38 is allowed to move relatively to the liquid piston 34 until the projections 33 formed on the inner circumferential surface of the cylindrical section 31 come into contact with the valve element 39 of the shaft member 38 to push the liquid piston 34 toward the container B, by further pushing the air piston 23 downwardly.

When the liquid piston 34 is pushed down, the valve seat 40 of the liquid piston 34 is isolated from the valve element 39 of the shaft member 38 so that the liquid chamber 36 and the mixing chamber 32 are communicated with each other through a clearance created between the shaft member 38 and the valve seat 40. In this situation, the spring 37 is compressed by the liquid piston 34 being pushed downwardly and an inner volume of the liquid chamber 36 is reduced. Consequently, an internal pressure of the liquid chamber 36 is raised so that the ball 47 of the ball valve 45 is pushed strongly onto the valve seat 46. In this situation, therefore, the liquid chamber 36 is still shielded from the internal space of the container B, and the contents held in the liquid chamber 36 is pushed out to the mixing chamber 32 through the clearance between the shaft member 38 and the valve seat 40.

When the air piston 23 is pushed down toward the container B, the contact portion 25 is moved below the first suction inlet 21. Consequently, the air chamber 54 created between the outer circumferential surface of the air cylinder 18 and the action valve 22 is communicated with the external space of the container B via the first suction inlet 21 so that the pressure in the air chamber 54 is equalized to the atmospheric pressure. In this situation, since the internal pressure of the container B is substantially equalized to the atmospheric pressure, the action valve 22 is not deformed by a load to be isolated from the outer circumferential surface of the air cylinder 18. In addition, as a result of pushing down the air piston 23, the inner volume of the air chamber 26 is reduced. Consequently, the internal pressure of the air chamber 26 is raised so that the air-suction valve 29 is pushed onto the second suction inlet 27. Whereas, the air-discharging valve 30 is isolated from the flange 35 of the liquid piston 34. As a result, the air in the air chamber 26 flows out of the air-discharging valve 30, and pushed into the mixing chamber 32 through the air passage formed in the joint site between the cylindrical section 31 and the liquid piston 34.

Since the liquid piston 34 is joined to the air piston 23, the liquid piston 34 is pushed down integrally with the air piston 23, and the inner volume of the liquid chamber 36 is reduced by the liquid piston 34 being pushed downwardly. Consequently, the internal pressure of the liquid chamber 36 is raised so that the ball 47 of the ball valve 45 is maintained to be pushed onto the valve seat 44 by the internal pressure of the liquid chamber 36. In this situation, therefore, the contents held in the liquid chamber 36 is pushed out by the above-mentioned internal pressure to the mixing chamber 32 through the clearance between the valve seat 40 and the valve element 39.

The clearance between the shaft member 38 and the valve seat 40 is narrow, and the clearance between the cylindrical section 31 and the valve element 39 is also narrow. Therefore, the contents in the liquid chamber 36 is delivered to the mixing chamber 32 at a high speed, and the air pushed out of the air chamber 26 is delivered to the mixing chamber 32 also at a high speed. For these reasons, the air and the contents are mixed with each other while being agitated to form a foam.

When the nozzle member 8 is further pushed downwardly, the projections 33 come into contact with the valve element 39 of the shaft member 38. In this situation, by further pushing down the nozzle member 8, the shaft member 38 is pushed down toward the container B by the pistons 23 and 34. That is, the shaft member 38 is moved integrally with the pistons 23 and 34. In this situation, the shaft member 38 is moved relatively with respect to the cylinders 18 and 19, and the plug 42 of the shaft member 38 being pushed onto the inner circumferential surface of the retaining member 41 is moved toward the container B. Consequently, the inner volume of the air chamber 26 is further reduced so that the air in the air chamber 26 is pushed into the mixing chamber 32. Likewise, the contents in the liquid chamber 36 is pushed into the mixing chamber 32. As described, the air and the contents are mixed together to form a foam in the mixing chamber 32, and the foam is pushed out of the mixing chamber 32 toward the net holder 13 by the air pushed out of the air chamber 26 and the contents pushed out of the liquid chamber 36. The foam is finely smoothened and homogenized as a result of passing through the net holder 13, and flows through the flow passage P to be dispensed from the discharging outlet 10.

Thus, the pistons 23 and 34 are moved toward the container B, and the flange 35 of the liquid piston 34 eventually comes into contact with the boundary between the air cylinder 18 and the liquid cylinder 19. Consequently, the nozzle member 8 and the pistons 23 and 34 moving downwardly (i.e., being pushed downwardly) are stopped. The internal pressures of the air chamber 26 and the liquid chamber 36 are reduced as a result of discharging the air from the air chamber 26 and discharging the contents from the liquid chamber 36, and when the internal pressures of the air chamber 26 and the liquid chamber 36 are balanced with an external pressure, the contents are no longer discharged.

When the pushing force applied to the nozzle member 8 is cancelled, the nozzle member 8 and the pistons 23 and 34 are returned toward the neck portion of the container B by the elastic force of the spring 37. When the pistons 23 and 34 start being returned by the elastic force of the spring 37, a force other than the frictional force and the elastic force is not applied to the shaft member 38, therefore, the shaft member 38 is fixed by the retaining member 41 with respect to the cylinders 18 and 19. That is, the pistons 23 and 34 are moved relatively with respect to the shaft member 38, and as a result, the valve seat 40 formed on one end of the liquid piston 34 comes close to the valve element 39 formed on one end of the shaft member 38.

When the liquid piston 34 returns to the neck portion of the container B, the inner volume of the liquid chamber 36 is increased, and the internal pressure of the liquid chamber 36 is reduced to the negative pressure that is lower than the atmospheric pressure. In the situation where the valve seat 40 of the liquid piston 34 has not yet come into contact with the valve element 39 of the shaft member 38, the clearance is still maintained between the valve seat 40 and the valve element 39, and the liquid chamber 36 is connected to the mixing chamber 32, the flow passage P, and the discharging outlet 10 via the clearance. Therefore, the foam of the contents remaining in the flow passage P between the discharging outlet 10 and the liquid chamber 36 is sucked into the liquid chamber 36 at least partially by a suction power derived from the above-mentioned negative pressure. Such action to suck the foam of the contents into the liquid chamber 36 from the flow passage P continues as long as the nozzle member 8 and the pistons 23 and 34 are returned by the elastic force of the spring 37, until the valve seat 40 comes into contact with the valve element 39 to disconnect the liquid chamber 36 from the flow passage P. In this situation, the ball 47 is isolated from the valve seat 46 of the ball valve 45 by the negative pressure in the liquid chamber 36 so that the liquid held in the container B is sucked into the liquid chamber 36 via the tube 48. Here, the foam of the contents is lighter than the contents in the liquid phase, and hence it is easily to be sucked into the liquid chamber 36 by the negative pressure. Therefore, a larger amount of the foam is sucked into the liquid chamber 36 than the contents in the liquid phase.

When the air piston 23 is returned toward the neck portion of the container B by the elastic force of the spring 37, the inner volume of the air chamber 26 is increased, and the internal pressure of the air chamber 26 is reduced to the negative pressure that is lower than the atmospheric pressure. Consequently, the air-discharging valve 30 is pushed onto the flange 35 of the liquid piston 34 to be closed by the negative pressure in the air chamber 26. Whereas, the air-suction valve 29 is deformed toward the air chamber 26 to be isolated from the piston head 24 thereby opening the second suction inlet 27. As a result, the space above the piston head 24 is communicated with the air chamber 26 via the second suction inlet 27. Since the space above the piston head 24 is communicated with the external space of the container B via a clearance between the opening 7 and the nozzle member 8, the external air flows into the space above the piston head 24 via the clearance, and sucked into the air chamber 26 via the second suction inlet 27 by the negative pressure.

When the air piston 23 starts being returned, the air piston 23 is still pushed into the container B. In this situation, therefore, the contact portion 25 is positioned below the first suction inlet 21 in the axial direction, and the first suction inlet 21 is not closed by the contact portion 25. That is, the space above the piston head 24 is communicated with the air chamber 54 via the first suction inlet 21 so that the pressure in the air chamber 54 is equalized to the atmospheric pressure. Whereas, the pressure in the container B is reduced to the negative pressure as a result of sucking the liquid into the liquid chamber 36.

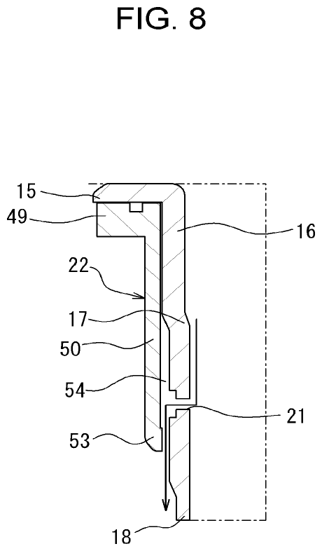

Specifically, the valve section 50 of the action valve 22 is subjected to a load corresponding to a product of: a difference between the external pressure of the container B and the internal pressure of the container B; and an area of the valve section 50 opposed to the air chamber 54. That is, the valve section 50 is elastically deformed radially outwardly by the above-mentioned load applied thereto to be isolated from the outer circumferential surface of the air cylinder 18. In addition, according to the exemplary embodiment of the present invention, the durometer hardness of the action valve 22 and the thickness of the valve section 50 are optimized such that the action valve 22 is actuated certainly by the above-mentioned pressure difference. Further, a pressure receiving area of the valve section 50 is increased by the air chamber 54 formed between the air cylinder 18 and the action valve 22. Therefore, the action valve 22 may be deformed by a relatively small pressure difference when the internal pressure of the container B is reduced to the negative pressure as a result of discharging the liquid therefrom. Consequently, as illustrated in FIG. 8, the bulge 53 is detached from the outer circumferential surface of the air cylinder 18 to open the first suction inlet 21 thereby introducing the external air into the container B.

According to the exemplary embodiment of the present invention, the durometer hardness of the elastic material of the action valve 22 and the thickness of the valve section 50 are further optimized such that the bulge 53 will not be detached from the outer circumferential surface of the air cylinder 18 by the vibrations during transportation. Therefore, the first suction inlet 21 will not be opened undesirably during transportation so that intrusion of the contents into the air cylinder 18 and the air chamber 26 via the first suction inlet 21 can be prevented. The above-explained action of the action valve 22 to introduce the external air into the container B via the first suction inlet 21 continues until the first suction inlet 21 is closed by the contact portion 25 of the air piston 23, or until the internal pressure of the container B comes into balance with the external pressure.

When the nozzle member 8 and the pistons 23 and 34 are further returned toward the neck portion of the container B by the elastic force of the spring 37, the valve seat 40 is pushed onto the valve element 39 of the shaft member 38 thereby disconnecting the liquid chamber 36 from the flow passage P. In this situation, the shaft member 38 is integrated with the pistons 23 and 34. Consequently, suction of the foam of the contents from the side of the discharging outlet 10 by the negative pressure in the liquid chamber 36 stops. In this situation, however, the liquid chamber 36 is still communicated with the internal space of the container B via the ball valve 45. Therefore, the liquid held in the container B is sucked into the container B through the tube 48 by the negative pressure. Also, the air chamber 26 is still communicated with the external space in this situation. Therefore, the inner volume of the air chamber 26 is increased with the return of the air piston 23, and the external air is introduced into the container B via the second suction inlet 27 by the negative pressure derived from such increase in the inner volume of the air chamber 26. In addition, in the situation where the first suction inlet 21 has not yet been closed by the contact portion 25 of the air piston 23, the bulge 53 of the action valve 22 is isolated from the outer circumferential surface of the air cylinder 18 by the above-explained principle so that the external air is introduced into the container B.

When the pistons 23 and 34 are further returned, the plug 42 of the shaft member 38 is engaged with the hook 43 thereby stopping the nozzle member 8 and the pistons 23 and 34 being returned. Eventually, when the internal pressures of the liquid chamber 36 and the container B are balanced with each other, suction of the contents into the liquid chamber 36 stops. Likewise, when the internal pressures of the space above the piston head 24 and the air chamber 26 are balanced with each other, that is, when the internal pressure of the air chamber 26 is brought back to the atmospheric pressure, introduction of the external air into the air chamber 26 via the air-suction valve 29 stops. In this situation, the first suction inlet 21 is closed by the contact portion 25 thereby disconnecting the internal space of the container B from the external space. When the internal pressures of the air chamber 26 and the container B are in balance with each other, the bulge 53 of the action valve 22 is brought into contact with the outer circumferential surface of the air cylinder 18 to shield the first suction inlet 21 from the internal space of the container B. As a result, the dispensing device 1 is brought into the condition shown in FIG. 1.

In order to evaluate the sealing tightness and the sealing integrity of the action valve 22 to shield the first suction inlet 21 from the internal space of the container B, an experimentation was conducted by the following procedures. For this purpose, the action valves 22 were prepared using synthetic resins having durometer hardness of 60, 80, 90, and 95, respectively. The remaining structures of the action valves 22 such as dimensions and thicknesses of the action valves 22 were substantially identical to one another. Those action valves 22 were individually fitted onto the dispensing devices 1, and in addition, the dispensing device 1 without having the action valve 22 was also prepared. Those dispensing devices 1 were mounted on containers B individually filled with 300 ml of colored water as the contents. Those containers B were laid in a vacuum chamber depressurized to −70 kPa for approximately ten minutes, and taken out of the vacuum chamber ten minutes after to visually confirm an occurrence of intrusion of the water into the air chambers 26 of the containers B and leakage of the water from the container B. In the following explanations, the dispensing device 1 on which the action valve 22 made of the elastic material having the durometer hardness of 60 will be referred to as the dispensing device 1 according to the first example. Likewise, the dispensing device 1 on which the action valve 22 made of the elastic material having the durometer hardness of 80 will be referred to as the dispensing device 1 according to the second example, the dispensing device 1 on which the action valve 22 made of the elastic material having the durometer hardness of 90 will be referred to as the dispensing device 1 according to the third example, and the dispensing device 1 on which the action valve 22 made of the elastic material having the durometer hardness of 95 will be referred to as the dispensing device 1 according to the fourth example. Whereas, the dispensing device 1 without having the action valve 22 will be referred to as the dispensing device 1 according to the comparative example.

(Evaluation)

In the container B on which the dispensing device 1 according to the comparative example was mounted, the water exists in the air chamber 26 of the dispensing device 1. That is, intrusion of the water into the air chamber 26 was confirmed. Whereas, in the container B on which the dispensing device 1 according to the fourth example was mounted, leakage of the water from the container B was confirmed. In this case, since the durometer hardness of the action valve 22 was too hard, clearances were created between the leading end of the neck portion of the container B and the annular section 49, and between the flange 15 of the air cylinder 18 and the annular section 49. Therefore, the sealing tightness of the annular section 49 as a sealing section or a packing section was insufficient. By contrast, the water was not found in the air chambers 26 and the external spaces of any of the containers B on which the dispensing devices 1 according to the first to third examples were mounted. That is, intrusion of the water into the air chambers 26 and leakage of the water from the containers B were not confirmed. In other words, the annular sections 49 effectively served as sealing sections or packing sections to shield the first suction inlets 21 tightly from the internal spaces of the containers B.

Based on the evaluations of the first to fourth examples and the comparative example, the action valve 22 formed of the elastic material having a durometer hardness from 60 to 90 is employed in the dispensing device 1 according to the exemplary embodiment of the present invention.

Although the above exemplary embodiments of the present invention have been described, it will be understood that the present invention should not be limited to the described exemplary embodiments. According to the foregoing embodiment of the present invention, the air chamber 54 is formed between the outer circumferential surface of the air cylinder 18 and the valve section 50 of the action valve 22. Instead, the first suction inlet 21 may also be closed directly by bringing the valve section 50 or the bulge 53 of the action valve 22 into contact with the first suction inlet 21 without forming the air chamber 54. In addition, the inner circumferential surface of the bulge 53 may be shaped into a wavy surface protruded and depressed alternately, instead of shaping into an arcuate surface having a constant curvature. That is, the structures to shield the first suction inlet 21 from the internal space of the container B airtightly and liquid-tightly should not be limited to those explained in the foregoing embodiment, and may be modified according to need in practical use.

1. A dispensing device, comprising:
a cap that is mounted on a neck portion of a container;
a cylinder that is fitted onto to an inner section of the cap while being communicated with an internal space of the container;
a piston that reciprocates in an axial direction within the cylinder while being in contact with an inner surface of the cylinder;
a nozzle member that is reciprocatably attached to the cap to be pushed in the axial direction toward the cylinder thereby pushing the piston;
a returning mechanism that pushes the piston back to an initial position;
a flow passage passing through the piston in the axial direction;
a nozzle hole that is communicated with one of openings of the flow passage;
an air chamber that is formed in one of internal spaces of the cylinder divided by the piston to which the other opening of the flow passage opens;
a valve mechanism that connects the air chamber to the internal space of the container and the flow passage when the nozzle member is pushed down;
an air inlet hole passing through a cylindrical portion of the cylinder in a thickness direction to connect the internal space of the container to an external space; and
an action valve that is fitted onto an outer circumferential surface of the cylinder to close the air inlet hole, and that is isolated from the outer circumferential surface of the cylinder to introduce external air to the container when an internal pressure of the container is reduced lower than an external pressure,
wherein:
the cylinder comprises a lower end portion and an upper end portion that is diametrically larger than the lower end portion; and
the action valve comprises
a ring-shaped annular section whose inner diameter is larger than at least an outer diameter of the lower end portion, and
a valve section that extends from the annular section in the axial direction to close the air inlet hole while maintaining a clearance from the air inlet hole in a radial direction of the container, so as to shield the air inlet hole from the internal space of the container.

2. The dispensing device as claimed in claim 1,
wherein the action valve further comprises a bulge that is formed on an end portion of the valve section opposite to the annular section to protrude radially inwardly to be in contact airtightly with the outer circumferential surface of the cylinder entirely, and
the clearance is created between the valve section and the outer circumferential surface of the cylinder by bringing the bulge into contact with the outer circumferential surface of the cylinder.

3. The dispensing device as claimed in claim 1, wherein the annular section serves as a packing section that is interposed between the cap and the neck portion in the axial direction.

4. The dispensing device as claimed in claim 1, wherein the upper end portion includes a fitting portion that is formed on the cylinder above the air inlet hole in the axial direction, and the annular section is fitted onto the fitting portion.

5. The dispensing device as claimed in claim 1, wherein the valve section has a tapered shape such that inner and outer diameters of the valve section are reduced gradually from the annular section toward a leading edge of the valve section opposite to the annular section in the axial direction.

6. The dispensing device as claimed in claim 1, wherein the action valve has hardness within a range from 60 to 90 measured by a durometer of type A defined by JIS-K6253 (ISO7619).

7. The dispensing device as claimed in claim 1, wherein a thickness of the valve section is set within a range from 0.3 mm to 2.0 mm.

8. The dispensing device as claimed in claim 1,
wherein an annular bead protruding radially outwardly is formed entirely on an outer circumferential surface of the upper end portion, and
an annular groove into which the annular bead is fitted airtightly is formed on an inner circumferential surface of the valve section entirely in the vicinity of the annular section.
